(19) United States
(12) Patent Application Publication
(10) Pub. No.: US 2018/0026556 A1
(43) Pub. Date: Jan. 25, 2018

(54) MOTOR SYSTEM WITH A CHANGEABLE POWER CAPACITY

(71) Applicant: Loong-Chiang HU, Taichung City (TW)

(72) Inventor: Loong-Chiang HU, Taichung City (TW)

(21) Appl. No.: 15/722,618

(22) Filed: Oct. 2, 2017

Related U.S. Application Data
(63) Continuation-in-part of application No. 14/942,248, filed on Nov. 16, 2015.

(30) Foreign Application Priority Data
Nov. 20, 2014 (TW) 103140222

(51) Int. Cl. H02P 5/46; G03G 15/00; H02P 21/00

(52) U.S. Cl. CPC H02P 5/46; H02P 21/0003; G03G 15/80

(57) ABSTRACT

A motor system includes at least two motors respectively having an output power and a rotary shaft, wherein at least one coupling is provided to connected the at least two rotary shafts. A detect unit is electrically connected to each of the at least two motors and detects the currents of the at least two motors and forms detecting signals relative to the current value of each of the at least two motors. A control unit is electrically connected to the at least two motors for receiving a controlling signal and the detecting signal for adjusting an output power to the electric actuator.

### CROSS-REFERENCE TO RELATED U.S. APPLICATIONS

This application is a Continuation-In-Part application of Ser. No. 14/942,248, filed Nov. 16, 2015, and entitled “MOTOR SYSTEM WITH A CHANGEABLE POWER CAPACITY AND CONTROL METHOD THEREOF”, presently pending.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

### 1. Field of the Invention

The present invention relates to a motor system, and more particularly to a motor system with a changeable power capacity and a control method thereof.

### 2. Description of Related Art Including Information Disclosed Under 37 CFR 1.97 and 37 CFR 1.98

For the accelerating requirements of an electric vehicle, a motor with a high power is provided for most electric vehicles for providing high torque during accelerating. However, the high power motor causes electric energy waste when the electric vehicle is idle or only needs a low load. It may cause an excitation waste when the high power motor is an exciting motor. The above wastes correspond to the power capacity of the motor.

With reference to the following table:

| SPEED | POWER RATE |
|---|---|
| Km/hour | Kw |
| 25 | about 0.3 |
| 50 | about 2.4 |
| 100 | about 19.2 |
| 125 | about 37.5 |
| 150 | about 65 |

If the electric vehicle using a high power capacity motor with the power rate of 100 KW and driven under a speed of 125 km/hour, the no load power consume of the high power capacity motor is 5 KW (100 KW 5%). At this time, the rate of the no load power consumed is

$$\frac{5 KW}{5 KW + 37.5 KW} = 11.76 \%$$

The rate is usually ignored because it is low.

The no load power consume is reduced to

$$100 KW \times \frac{50 KM \text{/} H}{125 KM \text{/} H} \times 5 \% = 2 KW$$

when the electric vehicle is driven under a low speed such as 50 KM/hour. However, the driving power consumed is also reduced to 2.4 KW. Accordingly, rate of the no load power consume is greatly increased to

$$\frac{2 KW}{2 KW + 2.4 KW} = 45.5 \%$$

In other words, the power provided to the electric vehicle for driving 100 KM is used for 54.5% (54.5 KM). Consequently, the power is greatly consumed when the electric vehicle is driven at a low speed and the cruising endurance of the high power capacity motor is greatly reduced.

A low power capacity motor may solve the above problem. However, the low power capacity motor is poor when the electric vehicle is driven at high speed or needs emergency acceleration.

The present invention has arisen to mitigate and/or obviate the disadvantages of the conventional power motors.

### BRIEF SUMMARY OF THE INVENTION

The main objective of the present invention is to provide an improved motor system that has a changeable power capacity.

To achieve the objective, the motor system in accordance with the present invention comprises at least two motors respectively having an output power and a rotary shaft, wherein at least one coupling is provided to connected the at least two rotary shafts such that the at least two rotary shafts are simultaneously operated as a singular rotary shaft. A detect unit is electrically connected to each of the at least two motors, wherein the detect unit is provided to detect the currents of the at least two motors and forms detecting signals relative to the current value of each of the at least two motors. A control unit is electrically connected to the at least two motors for receiving a controlling signal and the detecting signals, wherein the control unit controls the at least two motors according to the received controlling signal and detecting signals for adjusting an output power over a power requirement of the electric actuator and approaching to the power requirement of the electric actuator. Further benefits and advantages of the present invention will become apparent after a careful reading of the detailed description with appropriate reference to the accompanying drawings.

### BRIEF DESCRIPTION OF THE SEVERAL VIEWS OF THE DRAWINGS

FIG. 1 is a schematic view of a first embodiment of a motor system with a changeable power capacity in accordance with the present invention.

FIG. 2 is a schematic view of a second embodiment of the motor system with a changeable power capacity in accordance with the present invention.

### DETAILED DESCRIPTION OF THE INVENTION

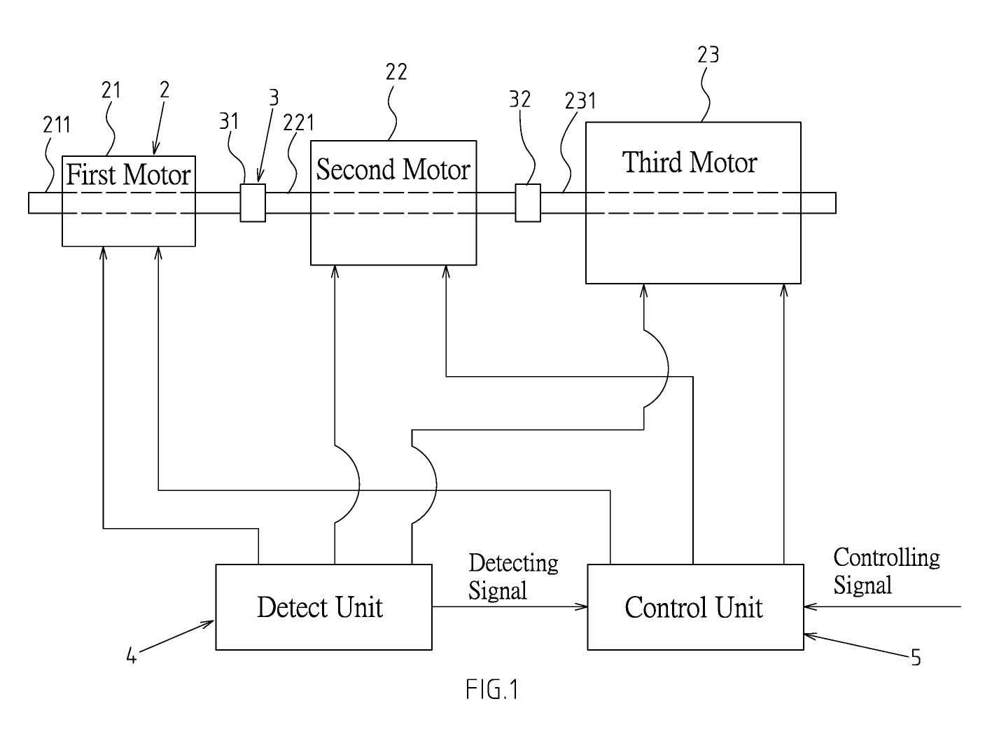

Referring to the drawings and initially to FIG. 1, a motor system with a changeable power capacity in accordance with the present invention is adapted to be disposed in an electric actuator and comprises a motor unit 2, a coupling unit 3 connected to the motor unit 2, a detect unit 4 electrically connected to the unit 2 and a control unit 5, wherein the control unit 5 is electrically connected to the motor unit 2 and the detect unit 4.

In the preferred embodiment of the present invention, the electric actuator is an electric vehicle.

In the preferred embodiment of the present invention, the motor unit 2 includes motors respectively defined as a first motor 21, a second motor 22 and a third motor 23. The number of the motors is according to the actual output demand of the motor unit 2.

Each of the first motor 21, the second motor 22 and the third motor 23 respectively includes a rotary shaft respectively defined as a first rotary shaft 211, a second rotary shaft 221 and a third rotary shaft 231. In the preferred embodiment of the present invention, the first motor 21, the second motor 22 and the third motor 23 respectively has an output power different from one another for being coupled with the control unit 5. However, the first motor 21, the second motor 22 and the third motor 23 can also has an output power equal to one another.

The coupling unit 3 includes a first coupling 31 and a second clutch 32, wherein the first clutch 31 is provided to connect the first rotary shaft 211 and the second rotary shaft 221, and the second coupling 32 is provided to connect the second rotary shaft 221 and the third rotary shaft 231 such that the first rotary shaft 211, the second rotary shaft 221 and the third rotary shaft 231 are operated as a singular rotary shaft.

The detect unit 4 is provided to detect the currents of the first motor 21, the second motor 22 and the third motor 23 and forms detecting signals relative to the current values of the first motor 21, the second motor 22 and the third motor 23.

In the preferred embodiment of the present invention, the detect unit 4 is provided to detect the current. However, the detect unit 4 can be also provided to detect output kinetic energy or the operating data of the motor unit 2.

The control unit 5 is electrically connected to the first motor 21, the second motor 22, the third motor 23 and the detect unit 4 for receiving a control signal and a detecting signal. The control unit 5 selectively starts/shuts the first motor 21, second motor 22 and the third motor 23 for adjusting the total output power of the motor unit 2 to match with the requirement of the electric actuator due to the received control signal and detecting signal.

The control unit 5 starts more motors to increase the sum of output power when the power requirement of the electric actuator is greater than the sum of the output power. The control unit 5 closes a corresponding one of the motors to make the output power approaching to the power requirement of the electric actuator when the power requirement of the electric actuator is smaller than the sum of the output power and the difference is greater than the output power of one of the motors.

In the preferred embodiment, the control signal is outputted from an accelerator that is mounted on the electric vehicle.

For example and easily understand the present invention, the output powers of the first motor 21, the second motor 22 and the third motor 23 are respectively defined as 5 KW, 50 KW and 100 KW. In the initial state, the control unit 5 firstly starts the first motor 21 to provide 5 KW output power, wherein the second motor 22 and the third motor 23 are idle.

When the power requirement of the electric vehicle is greater than 5 KW, the current value corresponding to the detecting signal from the detect unit 4 is greater than a first desired value or the rate of accelerator pedal deepness corresponding to the controlling signal reaches a first deepness, the control unit 5 further starts the second motor 22 such that the first motor 21 and the second motor 22 are simultaneously operated and prevent an inrush current, wherein the total output power of the motor unit 2 is 55 KW(5 KW+50 KW).

When the power requirement of the electric vehicle is greater than 55 KW, the current value corresponding to the detecting signal from the detect unit 4 is greater than a second desired value or the rate of accelerator pedal deepness corresponding to the controlling signal reaches a second deepness, the control unit 5 further starts the third motor 23 such that the first motor 21, the second motor 22 and the third motor 23 are simultaneously operated, wherein the total output power of the motor unit 2 is 155 KW(5 KW+50 KW+100 KW).

When the power requirement of the electric vehicle is reduce and the power requirement of the electric vehicle is smaller than the total output power of the motor unit 2, and the difference is greater and one of the motors of the motor unit 2, for example, the power requirement of the electric vehicle is reduced from 155 KW to 55 KW/under 55 KW, the control unit 5 stops the third motor 23 such that the sum of the output power of the motor unit 2 is returned to 55 KW(5 KW+50 KW).

With reference to the above paragraph, for preventing the control unit 5 being frequently operated when the power requirement of the electric vehicle near 55 KW, a delay time is preset into the control unit 5 when the power requirement is reduce to 55 KW.

When the power requirement of the electric vehicle is continually reduce and the power requirement of the electric vehicle is smaller than the total output power (5 KW) of the motor unit 2, the control unit 5 further closes the second motor 22 after the preset delay time.

When the first motor 21, the second motor 22 and the third motor 23 are magnet motors and respectively have a magnet coil, and the control unit 5 prepares to respectively close the first motor 21, the second motor 22 and the third motor 23, the magnet coils are interrupted. The power is firstly provided to the magnet coils and secondly provided to the first motor 21, the second motor 22 and the third 23 after about 0.1 to 2 seconds.

As described above, the motor system in accordance with the present invention has the following advantages.

First, the first motor 21, the second motor 22 and the third motor 23 are selectively connected to one another and the control unit 5 is sequentially start/close the first motor 21, the second motor 22 and the third motor 23 due to the control signal for adjusting the total output power of the motor unit 2 accordance to the power requirement of the electric actuator. Consequently, the problem of power waste is solved when the motor with high power capacity is used in a low load or idle, and a motor with high power capacity can be used for high power requirement, such as an accelerating or a high speed drive. As a result, the power is greatly saved and the cruising endurance of the electric actuator is improved.

Second, the detect unit 4 is provided to detect the electric currents of the first motor 21, the second motor 22 and the third motor 23, and the control unit 5 timely starts/closes the first motor 21, the second motor 22 and the third motor 23 such that the total output power of the motor unit 2 is timely adjusted.

Third, the detect unit 4 is provided to detect the electric currents of the first motor 21, the second motor 22 and the third motor 23 and feeds back to the control unit 5. Consequently, the control unit 5 judges the operating conditions of the first motor 21, the second motor 22 and the third motor 23 for timely controlling the first motor 21, the second motor 22 and the third motor 23.

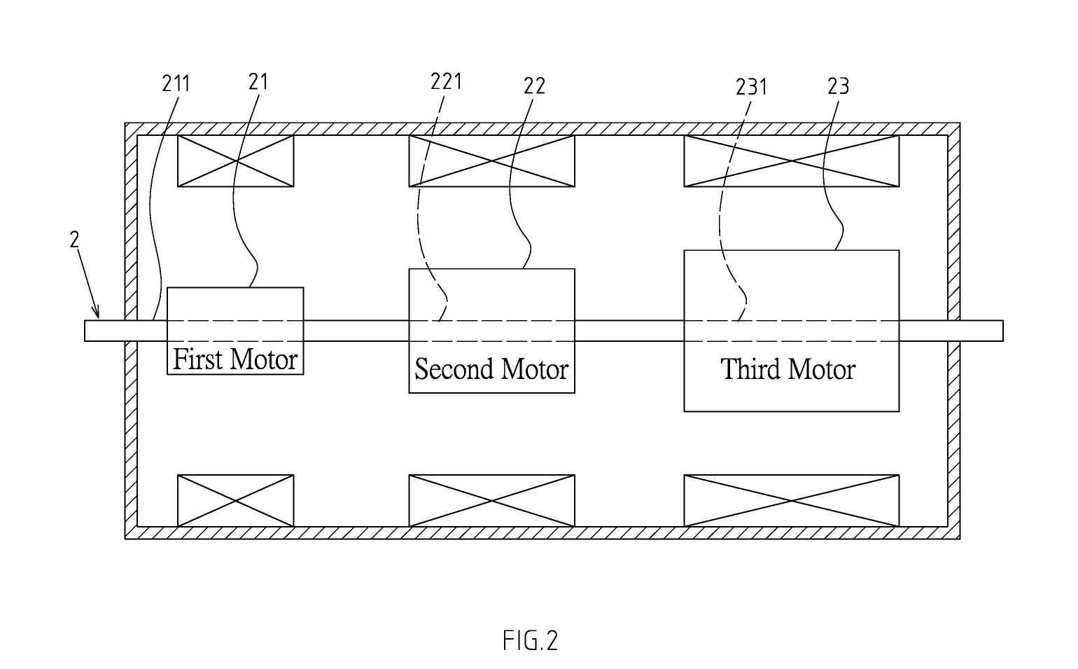

With reference to FIG. 2 that shows a second embodiment of the motor system in accordance with the present invention, in this embodiment, the first motor 1, the second motor 22 and the third motor 23 are integrated to a singular motor apparatus, wherein the first rotary shaft 211, the second rotary shaft 221 and the third rotary shaft 231 are sequentially integrally and co-axially connected and operated as a singular rotary shaft, the control unit 5 respectively controls the first motor 21, the second motor 22 and the third motor 23 by an electromagnet switch or a power transistor.

Accordingly, the second embodiment provides the purpose and function as well as the first embodiment, hereinbefore. In addition, the first motor 21, the second motor 22 and the third motor 23 are integrated to a singular motor apparatus and use a singular rotary shaft such that the first coupling 31 and the second coupling 32 of the first embodiment is unnecessary to the second embodiment. Consequently, the structures of the first embodiment are simplified, the volume of the structures of the first embodiment is reduced and can be easily operated. In addition, the first motor 21, the second motor 22 and the third motor 23 is randomly operated such that the operations of the second embodiment is more changeable that that of the first embodiment.

Although the invention has been explained in relation to its preferred embodiment, it is to be understood that many other possible modifications and variations can be made without departing from the spirit and scope of the invention as hereinafter claimed.

I claim:

1. A motor system with a changeable power capacity for being used in an electric actuator, comprising:
at least two motors respectively having an output power and a rotary shaft, wherein at least one coupling is provided to connected the at least two rotary shafts such that the at least two rotary shafts are simultaneously operated as a singular rotary shaft;
a detect unit electrically connected to each of the at least two motors, wherein the detect unit is provided to detect the currents of the at least two motors and forms detecting signals relative to the current value of each of the at least two motors; and
a control unit electrically connected to the at least two motors for receiving a controlling signal and the detecting signals, the control unit controlling the at least two motors according to the received controlling signal and detecting signals for adjusting an output power over a power requirement of the electric actuator and approaching to the power requirement of the electric actuator.

2. The motor system with a changeable power capacity for being used in an electric actuator as claimed in claim 1, wherein the at least two motors respectively have an output power different from each other.

3. The motor system with a changeable power capacity for being used in an electric actuator as claimed in claim 2, wherein the at least two motor are magnet motors and respectively have a magnet coil, and the magnet coil is interrupted when the control unit closes a corresponding one of the at least two motors.

4. A motor system with a changeable power capacity for being used in an electric actuator, comprising:
at least two motors respectively having an output power and a rotary shaft, wherein the at least two rotary shafts are sequentially integrally and co-axially connected and simultaneously operated as a singular rotary shaft;
a detect unit electrically connected to each of the at least two motors, wherein the detect unit is provided to detect the currents of the at least two motors and forms detecting signals relative to the current value of each of the at least two motors; and
a control unit electrically connected to the at least two motors for receiving a controlling signal and the detecting signals, the control unit controlling the at least two motors according to the received controlling signal and detecting signals for adjusting an output power over a power requirement of the electric actuator and approaching to the power requirement of the electric actuator.

5. The motor system with a changeable power capacity for being used in an electric actuator as claimed in claim 4, wherein the at least two motors respectively have a output power different from each other.

6. The motor system with a changeable power capacity for being used in an electric actuator as claimed in claim 5, wherein the at least two motor are magnet motors and respectively have a magnet coil, and the magnet coil is interrupted when the control unit closes a corresponding one of the at least two motors.
